(19) United States
(12) Patent Application Publication
(10) Pub. No.: US 2006/0059142 A1
(43) Pub. Date: Mar. 16, 2006

(54) System and method of modifying an on-line dating search using inline editing

(75) Inventors: Stanislav Zvinyatskovsky, Mountain View, CA (US); Michael Kronthal, Redwood City, CA (US); Brenten D. Pennock, San Jose, CA (US); Tracy D. Rocca, Albuquerque, NM (US); Ramsey M. Ksar, San Jose, CA (US); Grant C. Wong, Santa Cruz, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/218,904

(22) Filed: Sep. 2, 2005

Related U.S. Application Data
(60) Provisional application No. 60/610,125, filed on Sep. 15, 2004.

(51) Int. Cl. G06F 17/30

(52) U.S. Cl. 707/5

(57) ABSTRACT

A method, system, and apparatus are directed towards enabling a subscriber of an online dating service to perform a search for potential candidates to a long-term relationship. Various search criteria may be employed to generate an initial list of candidates. The invention employs the search criteria to identify a potential candidate list for the user. The invention further allows the user to edit inline with a display of the potential candidates various search criteria components using, for example, a drop-down menu to identify an importance of a search criteria component, or to otherwise revise the search criteria. The revised search criteria may then be employed in revising the potential candidate list.

### CROSS-REFERENCE TO RELATED APPLICATIONS

This application claims the benefit of U.S. Provisional Application Ser. No. 60/610,125 filed on Sep. 15, 2004, the benefit of the earlier filing date of which is hereby claimed under 35 U.S.C. § 119 (e) and further incorporated by reference.

### FIELD OF THE INVENTION

The present invention relates generally to online dating services, and more particularly, but not exclusively, to a system and method for automatically modifying search criteria, based, at least in part, on a use of an inline editing mechanism.

### BACKGROUND OF THE INVENTION

Dating services are now so popular that by at least one study for the given year, over twenty-six percent of all Internet users in America have visited a personals website. Part of the reason may be that online dating may appear to be a natural extension of where people are at this point in time. That is, many people today, have personal computers, or at least access to a personal computer. Moreover, virtually everyone wants to fall in love. Thus, it is natural to merge these two things. As such, online dating services may appear as the world's biggest singles bar. Except that it can be done in the privacy of one's own home where time may be taken to read about another person and get to know them through email, phone, and the like, before ever going on an actual date.

Thus, there has been a flurry of companies launching services that help people to meet and develop a personal relationship. Many of these companies, however, are/struggling with developing additional services that will build customer loyalty. Without the ability to extend the value of the online dating experience, online dating may lose its appeal. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 shows one embodiment of an example screen layout of a candidate list in a side-by-side display with inline search criteria;

FIG. 4 shows one embodiment of an example screen layout with inline search criteria employed to modify a search criterion;

FIG. 5 shows one embodiment of an example screen layout with inline search criteria employed to modify another search criterion; and

FIG. 6 illustrates a logical flow diagram generally showing one embodiment of a process for managing an online dating search using inline editing of search criteria, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the present invention is directed towards enabling a subscriber of an online dating service to modify a search result for potential candidates to a long-term relationship. Various search criteria may be employed to generate an initial list of candidates, including, but not limited to, personality, relationship, and affinity components, a one-way score, a reverse score, location, activity level, a previous level of interest, compatibility components. A user may provide, for example, information about them self by answering a series of questions. The invention employs the information to identify a potential candidate list for the user. The invention further allows the user to edit inline with the display of the potential candidates various search criterion using, for example, a drop-down menu to identify an importance of a search criterion, or to otherwise revise the search criteria. The revised search criteria may then be employed in revising the potential candidate list.

Illustrative Operating Environment

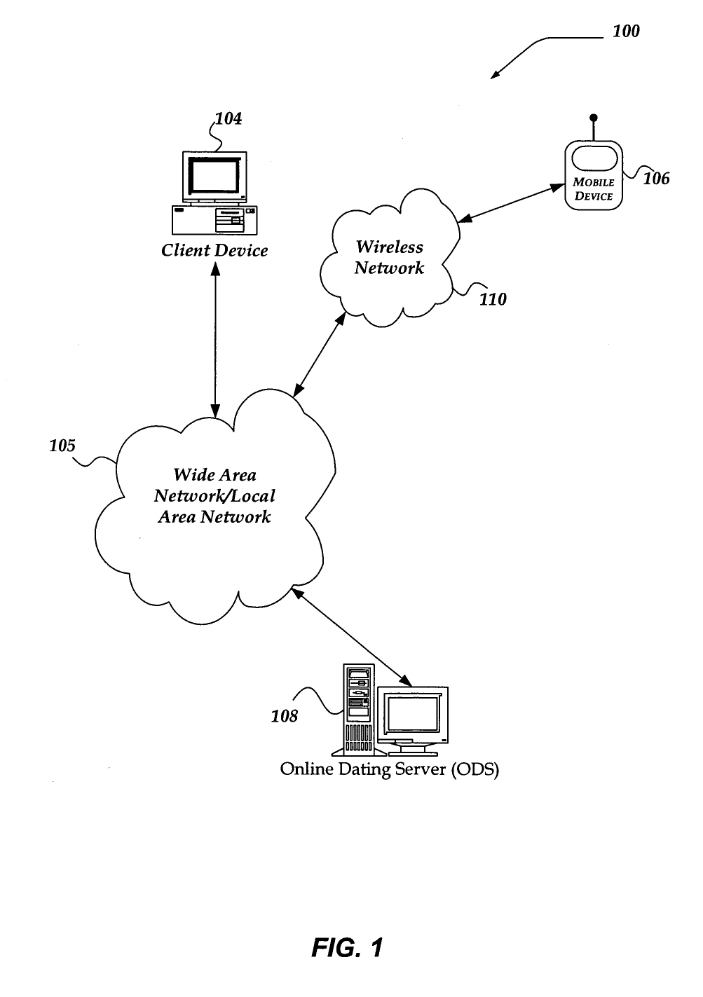

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client devices 102-104, network 105, and online dating server (ODS) 106. Network 105 is in communication with and enables communication between each of client devices 102-104, and ODS 106.

Client devices 102-104 may include virtually any computing device capable of receiving and sending a message over a network, such as network 105, to and from another computing device, such as ODS 106, each other, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client devices 102-104 may be any device that is capable of connecting using a wired or wireless communication medium such as a PDA, POCKET PC, wearable computer, and any other device that is equipped to communicate over a wired and/or wireless communication medium.

Each client device within client devices 102-104 may include a browser application that is configured to receive and to send web pages, web-based messages, and the like. The browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Client devices 102-104 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

Client devices 102-104 may be further configured to enable a user to participate in an online dating service, manage personal user information associated with the online dating service, and the like, which may in turn be saved at a location, such as ODS 106, and the like. As such, client devices 102-104 may further include a client application that is configured to manage various actions on behalf of the client device. For example, the client application may enable a user to interact with the browser application, email application, and the like, to manage their online dating information. For example, the user may employ the client application, in part, to create a user profile, participate in an online dating personality analysis, such as a personality type and love styles test, a relationship test, and the like. The client application may further enable the user to receive and interact with results of a search that is based, at least in part, on the user's input to the online dating service.

The client application may also interact with another application to allow the user to edit, inline with a side-by-side display of a potential candidate list, various search criterion, for use in modifying the search for a potential candidate. For example, the client application may allow the user to interact with a browser application that provides a set of possible search criteria. Such search criteria may include, for example, an age group, a location, distance, activity, language, personality type, love style, body type, characteristics of a body type, ethnicity, education, habits, religion, political, and other social characteristics. The user may employ a drop-down menu, selectable options, fill-ins, and the like, to refine, and/or revise a search criterion. The client application may further interact with the other application to allow the user to request a revised potential candidate list based on the results of the inline edits. Moreover, the client application may be enabled to allow the user to save the results of a search, and/or the search criteria.

The client application also may interact with various other components of the system as described in more detail below. For example, in at least one embodiment, the client application is configured to enable the user to provide a fee for at least a portion of the online dating service.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between client devices 102-104, and ODS 106.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

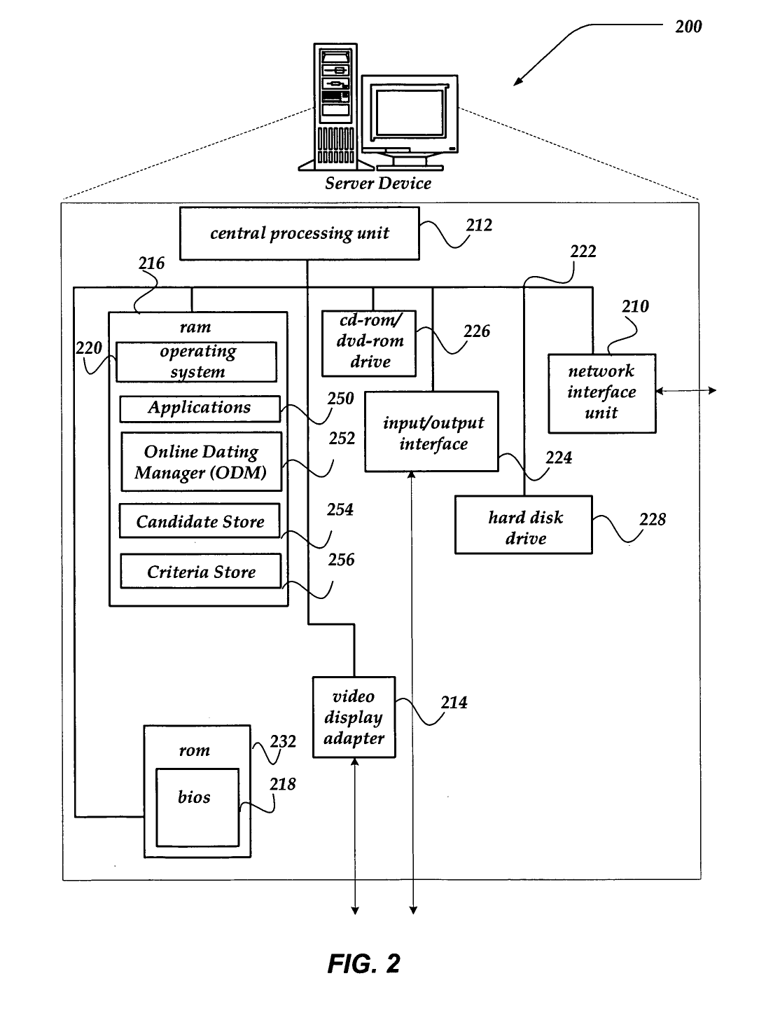

One embodiment of ODS 106 is described in more detail below in conjunction with FIG. 2. Briefly, however, ODS 106 may include any computing device capable of connecting to network 105 to enable a user of at least one of client devices 102-104 to manage their online dating activities and related information. Devices that may operate as ODS 106 include personal computers desktop computers, multiprocessor systems, microprocessor-based or programmable consumer electronics, network PCs, servers, and the like.

It is noted that while FIG. 1 illustrates a single computing device operable as ODS 106, the invention is not so limited. For example, the actions attributable to ODS 106 may be distributed across multiple computing devices, such as a group of servers, a network cluster, and the like, without departing from the scope or spirit of the invention.

Illustrative Server Environment

FIG. 2 shows one embodiment of a server device, according to one embodiment of the invention. Server device 200 may include many more components than those shown. The components shown, however, are sufficient to disclose an illustrative embodiment for practicing the invention.

Server device 200 includes processing unit 212, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server 102. As illustrated in FIG. 2, server device 200 also can communicate with the Internet, or some other communications network, such as network 105 in FIG. 1, via network interface unit 210, which is constructed for use with various communication protocols including the TCP/IP protocol. Network interface unit 210 is sometimes known as a transceiver, transceiving device, network interface card (NIC), and the like.

Server device 200 may also include an SMTP handler application for transmitting and receiving email. Server device 200 may also include an HTTP handler application for receiving and handing HTTP requests, and an HTTPS handler application for handling secure connections. The HTTPS handler application may initiate communication with an external application in a secure fashion.

Server device 200 also includes input/output interface 224 for communicating with external devices, such as a mouse, keyboard, scanner, or other input devices not shown in FIG. 2. Likewise, server device 200 may further include additional mass storage facilities such as hard disk drive 228. Hard disk drive 228 is utilized by server 102 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, web services, transcoders, database programs, word processing programs, spreadsheet programs, and so forth. Mass storage may further include online dating manager (ODM) 252, candidate store 254, and search store 265.

ODM 252 enables a user to manage their online dating user information, communicate with other users, and non-users, and to generally pursue an online dating relationship. ODM 252 provides a variety of features to enable a user of a client device to participate in the online dating experience.

For example, ODM 252 enables a user to search candidate store 254 for another person in the online dating service based, in part, on the user's provided search criteria, or other information. After identifying candidates, ODM 252 may analyze the user's evaluation of candidates for possible adjustments. For example, whether the user has contacted a candidate, the frequency of the user's contacts with the candidate, and the order in which the user contacted the candidates may serve as indicators of the user's opinion of the candidate. ODM 252 may then provide the user with a potential list of candidates.

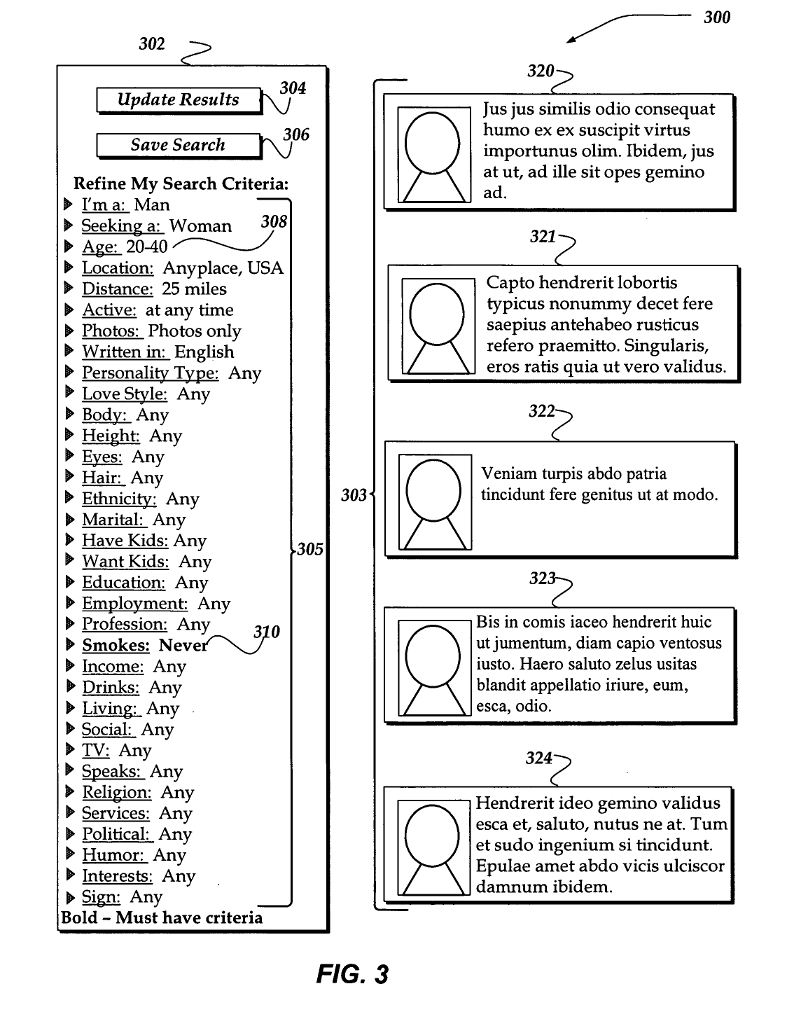

ODM 252 is further configured to provide on an inline screen layout, a set of search criteria for which the user may adjust their search results. Embodiments of various inline screen layouts are described in more detail in conjunction with FIGS. 3-5 below. Briefly, however, through the use of such inline screen layouts (e.g., user interfaces), ODM 252 enables a user to easily access and modify various search criteria, while simultaneously viewing the results of the search in the form of a list of candidate profiles. When the user so desires, ODM 252 enables the user to save, and/or update the search results using the modified inline search criteria.

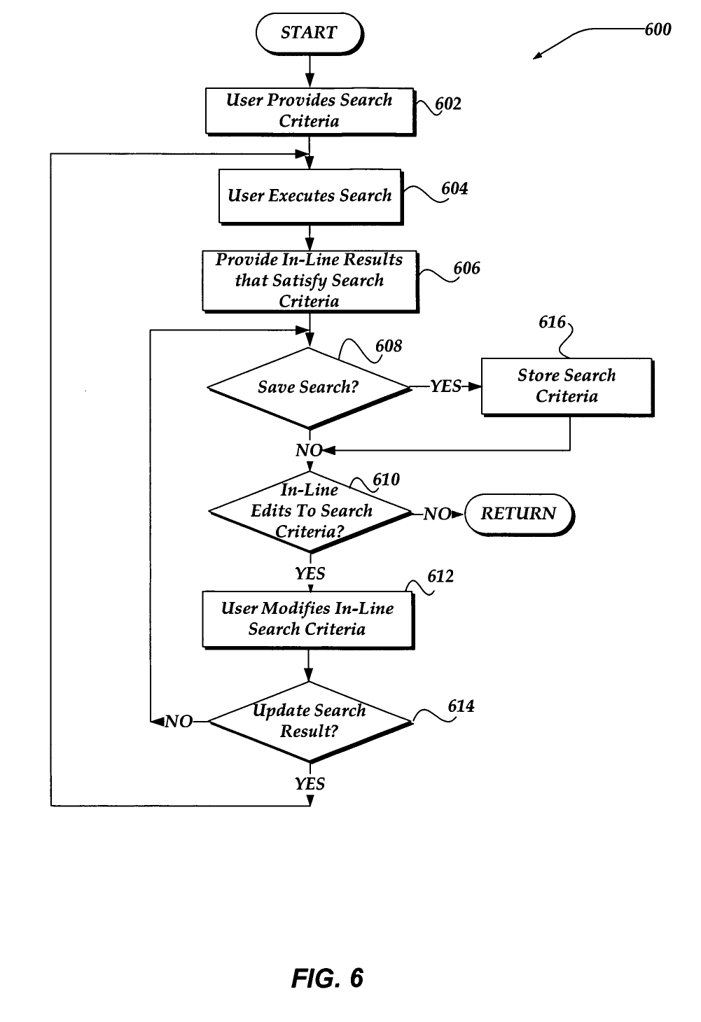

Moreover, ODM 252 may employ a process, such as process 600 described below in conjunction with FIG. 6 to perform actions, such as those described above.

Candidate store 254 may include virtually any mechanism that is configured to store and manage profiles of potential candidates for the online dating service. Candidate store 254 may be implemented as a database, folders, scripts, web pages, programs, XML documents, or the like.

Criteria store 256 may include virtually any mechanism that is configured to store and manage a user's search criteria and other information useable to generate search criteria, including test results, user's personal information, user's browsing history, contact histories, or the like. Criteria store 256 may be implemented as a database, folders, scripts, web pages, programs, XML documents, spreadsheets, or the like.

Furthermore, ODM 252's associated actions and/or sub-components may be decomposed and distributed across multiple computing devices similar to server device 200 of FIG. 2. For example, criteria store 256 may be distributed across one set of servers, while candidate store 254 may be distributed across another set of servers. In addition, a user interface sub-component of ODM 252 that may enable at least some of the displays of the inline search criteria side-by-side with search results may be distributed across still another server, array of servers, and the like.

Illustrative Inline Screen Layouts of Search Criteria

FIG. 3 shows one embodiment of a display for use in managing a subscriber's inline editing of search criteria, in accordance with the present invention. Display 300 may include many more components than those shown. The components shown, however, are sufficient to disclose an illustrative embodiment for practicing the invention.

As shown in the figure, display 300 includes candidate list 303, and inline search component 302 in a side-by-side view. Inline search component 303 further includes inline search criteria 305, update results icon 304, and save search icon 306. Candidate list 303 includes candidate profiles 320-324.

As shown, the invention enables a user to readily view inline search criteria 305 while also viewing candidate list 303 in a side-by-side display at the same time. This is directed towards minimizing the user having to swap screen layouts in order to select and modify various search criteria within inline search criteria 305 and to further view candidate profiles. Such inline screen layouts that provide a side-by-side viewing of the inline search criteria and candidate list may be achieved employing any of a variety of mechanisms, including web-based frames, a single HyperText Transport Protocol (HTTP) web page, java scripts, XML, applets, or the like.

It is noted that inline search criteria 305 illustrates some of a variety of possible search criteria that may be displayed for use in modifying search criteria inline. The invention, however, is not limited to the search criteria displayed, and virtually any other search criteria may be included in inline search criteria 305, without departing from the scope or spirit of the invention.

Moreover, inline search criteria 305 may include search criteria that may include yes/no inputs, range data, selection of one of more provided options, must have criteria selections, fill in the blanks, or the like. In one embodiment, must have criteria may be uniquely displayed, such as in bold, as shown in FIG. 3 for the inline search criteria “smokes” 310. As shown, the user has selected a must have criteria of “never.” Range data is also illustrated, for example, by the inline search criteria “age” 308 as 20-40 (years).

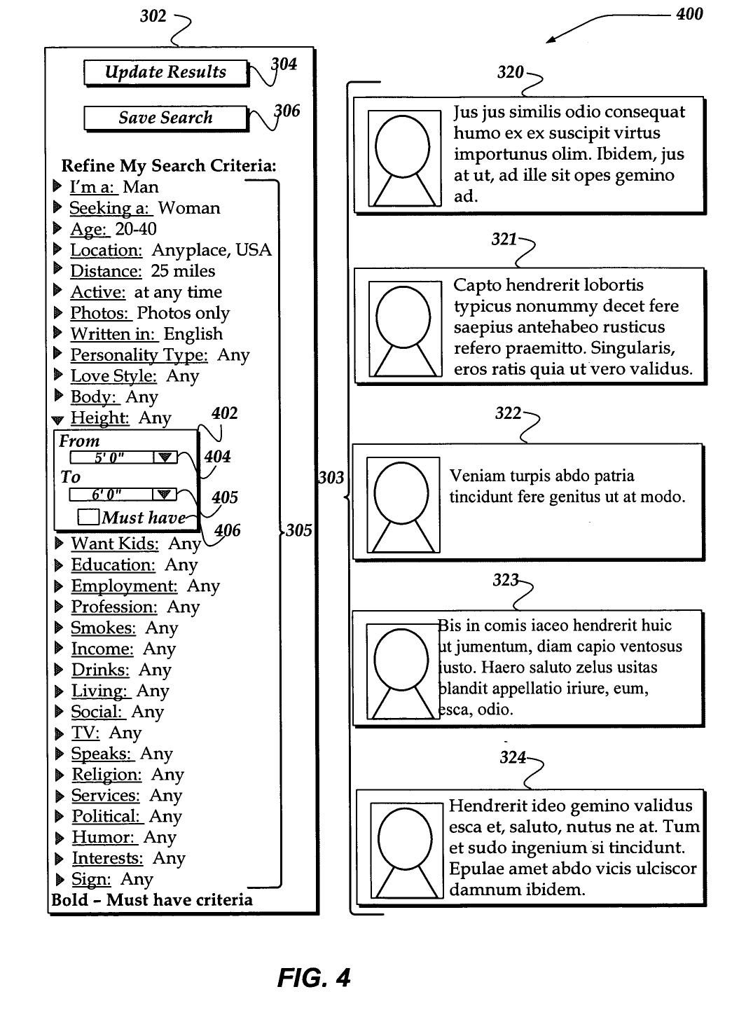

In one embodiment of an operation, a user may select an inline search criteria for modification using any of a variety of ways. For example, in one embodiment, the user may highlight the desired inline search criteria, and click on a mouse button, make a keyboard selection, or the like, to obtain a drop-down menu, or other form of input entry component. For example, FIG. 4 shows one embodiment of another example screen layout with inline search criteria where the user has selected to modify the inline search criteria “height.” The selection of the “height” inline search criteria has resulted, in this embodiment, in a display of drop-down menu 402. As shown, drop-down menu 402 is configured with range selection menu 404-405, and must have selection 406. The user may then select from a variety of heights a desired height range. Moreover, the user may select to indicate that the height range is a must have height range. That is, a candidate may be excluded from the candidate list, or otherwise relegated to a lower ranking in a rank sorted list of candidates.

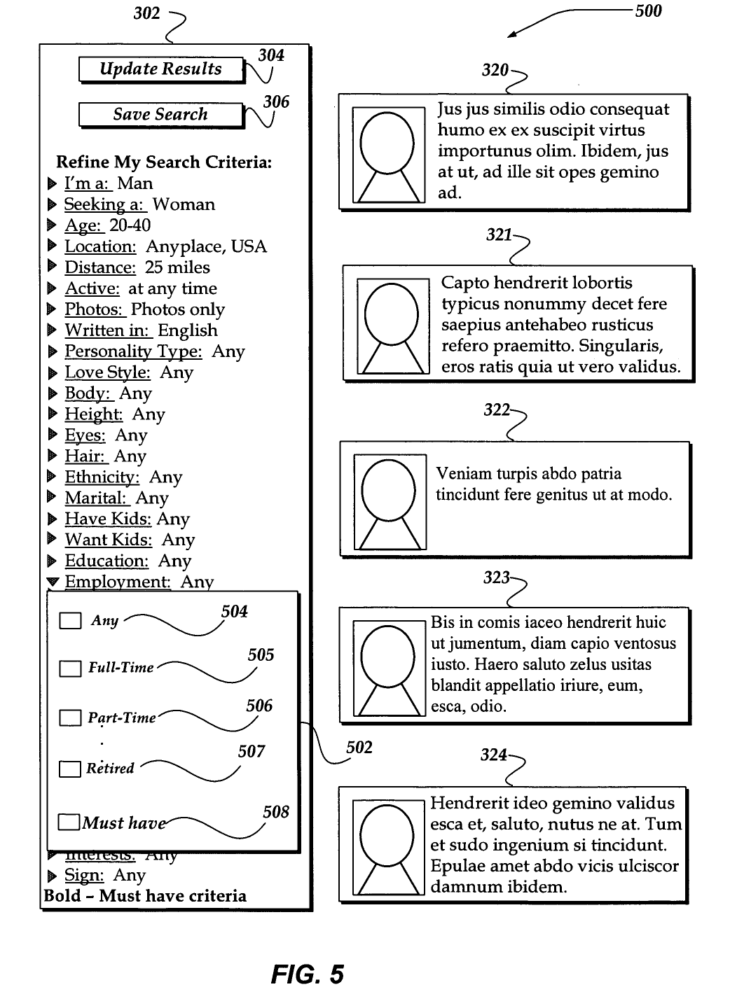

FIG. 5 shows one embodiment of yet another example screen layout with inline search criteria employed to modify another search criterion. As shown in FIG. 5, drop-down menu 502 illustrates possible selections for the inline search criteria “employment.” Not all possible selections are shown in the figure, for ease of readability. Thus, other possible selections may be included without departing from the scope of spirit of the invention. As shown however, the user may select as an “employment” status of any 504, full-time 505, part-time 506, retired 507, and must have 508. Again, selection of must have 508 indicates that potential candidates may be excluded or otherwise relegated to a lower ranking in a ranked ordered list of possible candidates based on whether a candidate's profile satisfies the selected search criteria.

Moreover, as the user selects various inline search criteria to modify, a currently opened drop-down menu may automatically close, when another drop-down menu is selected. Thus, for example, when transitioning from FIG. 4 to FIG. 5, the drop-down menu for “height” may automatically close as the user selects the drop-down menu for “employment” (or any other inline search criteria).

The present invention is not constrained, however, to selecting predefined values for an inline search criteria. For example, in one embodiment, the user may be provided a drop-down menu that enables entry of a user value. Thus, for example, the user may select to input an age range rather than select from a list of predefined values.

Also shown in FIGS. 3-5, update results icon 304 enables the user to employ the revised inline search criteria 305 to revise candidate list 303. Revising of candidate list 303 may be performed by searching a potential candidate database, folder, list, or the like, to select potential candidates that satisfy the selected inline search criteria. In one embodiment, the inline search criteria are employed to modify a weighted search score for each potential candidate. In another embodiment, the inline search criteria are employed to adjust results from a prior search by adjusting a rank order of candidates. For example, in one embodiment, assume that the user has modified an inline search criteria to indicate that the ages must be within a selected range of ages. The results displayed for the user may remove those candidates from the displayed list of potential candidates that fall outside of the must have selected range of ages. In another embodiment, the results displayed may reorder the potential list of candidates from a prior search, such that those candidates within the selected must have range of ages are displayed higher in a rank sorted order over those candidates that fall outside of the selected ages.

It is further noted that while FIGS. 3-5 illustrate drop-down menus, the invention is not so limited. For example, the invention may employ pop-ups, another browser window such as a mini-window, or any other mechanism useable to provide the user the ability to edit search criteria while simultaneously displaying the search criteria inline with the results of a search. Moreover, any of a variety of mechanisms may be employed for enabling the user to edit search criteria, including slider bar, a selection window, a fill in the blank window, a button, or the like.

In addition, while FIGS. 3-5 illustrate embodiments for displaying inline search criteria 305 side-by-side with candidate list 303, the display need not be arranged to show all candidates or even all of the inline search criteria at the same time. Thus, for example, FIGS. 3-5 may also represent scrollable windows, with a scroll bar, or the like, that enables the user to scroll up or down through the side-by-side display. In one embodiment, the user may be enabled to click on a next and/or a previous screen icon to view additional inline search criteria and/or candidates. However, each display screen is configured to provide the inline search criteria and candidates in a side-by-side view. Such approaches are provided to enable the user to view more candidates than may be viewable on the user's display device, monitor, or the like.

Generalized Operation

The operation of certain aspects of the invention will now be described with respect to FIG. 6. FIG. 6 illustrates a logical flow diagram generally showing one embodiment of process 600 for employing inline editing of search criteria to modify an online dating search, in accordance with the present invention.

As shown in the figure, process 600 typically begins, after a start block, at block 602, when a user indicates intent to participate in a long-term serious relationship and is willing to openly communicate this desire to others. At block 602, the user provides search criteria, such as basic information about them self, including such information as name, alias, age, gender, and so forth.

At block 602, the user may also participate in an initial test for compatibility. In one embodiment, the test includes a personality type and love style test that may focus on such personality elements as degree of extroversion, agreeableness, conscientiousness, neuroticism, openness, and so forth. However, the test is not so constrained, and virtually any test, series of questions, and the like, may be employed to enable the invention to obtain compatibility information about the user. The test may employ any of a variety of techniques to obtain such personality elements, including, providing questions, surveys, graphics, interactive audio clips, interactive video clips, and the like. In one embodiment, the results of the initial test may be provided to the user for review and/or refinement. The results may be presented to the user in a variety of formats, including a written summary that is organized based on personality, love style, and the like.

The user may also be offered an opportunity to submit to additional testing. For example, at block 602 the user may participate in a personality and relationship testing. In one embodiment, the additional testing is directed towards personality elements such as relationship readiness, relationship expectations, ambition, a desire to have children, emotional IQ, stereotypic gender roles, conflict resolution, and so forth. However, the invention is not constrained to these example elements, and others may be tested, without departing from the scope or spirit of the invention.

Upon completion of block 602, processing flows to block 604, where the user requests that a search be performed based on the provided search criteria and other inputs. Upon submission of this request processing proceeds to block 606.

At block 606, candidates are selected from a store of candidates who may satisfy the search criteria. In one embodiment, the results include at least those candidates that satisfy the must-have criteria that the user may have selected.

At block 606, the candidates may be obtained based on a unified search score (USS), described below, that may be determined for each candidate in the store of candidates. In one embodiment, the USS may represent a composite search ranking score determined from a weighted sum of various subscores. The subscores may, for example, be based, at least in part, on the results of the tests the user has taken, inline search criteria, and any additional input the user may have provided.

A variety of factors may be employed to generate the USS. Such factors, may include, an indication of the degree to which a candidate found by the search matches the user's criteria (one-way search), how much the user matches the criteria of a candidate found by a search (reverse search), indication of an activity level such as whether a candidate logged into the online dating service recently (activity level), an affinity indicating whether a candidate has a degree of closeness with another candidate found by a search (affinity), a previous level of interest indicating whether the user has viewed the same candidate before and did not contact the candidate, an input factor reflecting the number of replies the candidate's profile has recently received, and so forth.

In one embodiment, the inputs, and other factors are employed to generate the USS as:
USS=Sum(WᵢIᵢ), for i=1 through n,

where Wᵢ represents a weight for input factor Iᵢ and n represents the number of input factors. The input factors may include a variety of information. For example, in one embodiment, the USS may be determined based on an input factor associated with the initial test, the additional test, a one-way search criteria input factor, a reverse search criteria input factor, an activity input factor, a distance input factor, an affinity input factor, compatibility feedback input factor, inline search criteria, and the like. In one embodiment, the Wᵢ for the inline search criteria may be modified based on whether the inline search criteria is identified as a must have criterion. However, the invention is not so limited, and virtually any input factor may be employed.

It is noted however, that the present invention is not constrained to using the above described USS, and virtually any mechanism may be employed that combines the provided inputs, must-have criteria, inline edits of search criteria, and the like, to provide a list of potential candidates.

If the USS is employed, candidates may then be sorted based, in part, on their respective resulting USS. Otherwise, the candidates may be sorted based on virtually any desired criteria. For example, in one embodiment, the user may provide a sort key, such as age, distance from the user, or the like, that may be employed to rank order the candidate list.

Processing then flows to block 606, where the sorted candidate list is provided to the user. In one embodiment, the provided candidate list includes a predetermined number of candidates. For example, in one embodiment, the sorted candidate list may include a top most 1000 candidates. In another embodiment, the sorted candidate list is presented to the user in a navigable sequence of web pages along with the inline search criteria. Processing continues next to decision block 608.

At decision block 608, a determination is made whether to save the results of the search performed at block 606. If it is determined that the search results are to be saved, processing proceeds to block 616, where the current search results, and the search criteria is saved. In one embodiment, only the search criteria are saved. In this embodiment, the search criteria may be performed over a new or otherwise revised set of candidates. Processing then proceeds to decision block 610. If at decision block 608, however, the search results are not to be saved, processing also proceeds to decision block 610.

At decision block 610, a determination is made whether inline edits are to be performed on the inline search criteria. If not, processing returns to a calling process to perform other actions; otherwise, if inline editing is to be performed, processing continues to block 612.

At block 612, the user may modify one of more inline search criteria using any of a variety of mechanisms, including those described above in conjunction with FIGS. 3-5. Processing then flows to decision block 614, where a determination is made whether to update the search results by employing the revised inline search criteria (and/or other inputs) to modify the USS, and/or the rank ordering of the list of candidates. If the search results are to be updated, processing loops back to block 604 above; otherwise, processing loops back to decision block 608 above. Process 600 may continue until the user decides to exit the process.

In addition, the user is not wholly constrained to flow illustrated in FIG. 6 in other ways. For example, the user may execute a search at block 604, review the results at block 606, and revise the inline search criteria at block 612, without being constrained to view any of the candidate's profiles at block 606. Moreover, the user may elect to retake a test, revise their basic information and the like, without proceeding to perform a search, during a given session. Thus, it is apparent that FIG. 6 is but one embodiment of a process for employing compatibility feedback to automatically modify an online dating search.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for use in managing an online dating search, comprising:
determining a user's search criteria for a candidate for a dating relationship online;
performing a search for a list of candidates employing the search criteria;
ranking each candidate in the list of candidates;
displaying the ranked list of candidates inline with at least some of the search criteria;
editing the inline search criteria; and
employing the inline search criteria, including the edited search criteria, to revise the ranking of the candidates in the list of candidates.

2. The method of claim 1, wherein displaying the ranked list of candidates inline with at least some of the search criteria further comprises, providing a display screen with at least some of the search criteria side-by-side with the list of candidates.

3. The method of claim 1, wherein editing the inline search criteria further comprises:
selecting a search criterion with the displayed search criteria using a pull-down menu.

4. The method of claim 1, wherein editing the inline search criteria further comprises modifying at least one value associated with the inline search criteria.

5. The method of claim 1, wherein displaying the ranked list of candidates inline with at least some of the search criteria further comprises enabling the display to include a scrollable window.

6. The method of claim 1, wherein ranking each candidate further comprises: employing at least one of a user ranking criteria, or a ranking based on a unified search score.

7. A client device that is configured for use in communicating an online dating search, comprising:
a display;
a transceiver for receiving and sending information to another computing device;
a processor in communication with the display and the transceiver; and
a memory in communication with the processor and storing data and machine instructions that causes the processor to perform a plurality of operations, including:
providing a user's search criteria for a candidate;
enabling a search for a list of candidates employing the search criteria;
displaying the list of candidates inline with at least some of the search criteria;
editing the inline search criteria;
enabling a search for a revised list of candidates employing at least the edited inline search criteria; and
displaying the revised list of candidates inline with the edited inline search criteria.

8. The client device of claim 7, wherein the client device further comprises a mobile device.

9. The client device of claim 7, wherein editing the inline search criteria further comprises:
selecting a first search criterion in the displayed search criteria using a menu interface;
selecting a second search criterion in the displayed search criteria, wherein selecting the second search criterion automatically closes the menu interface associated with the first search criterion.

10. The client device of claim 7, wherein editing the displayed search criteria further comprises employing at least one of a slider bar, a drop-down menu, a button, or a fill in the blank.

11. The client device of claim 7, wherein editing the inline search criteria further comprises selecting at least one “must have” criterion for use in revising the list of candidates.

12. A server device that is configured for use in managing an online dating search, comprising:
a transceiver for receiving and sending information to another computing device;
a processor in communication with the transceiver; and
a memory in communication with the processor and storing data and machine instructions that cause the processor to perform a plurality of operations, including:
receiving a user's search criteria for a candidate;
performing a search for a list of candidates employing the search criteria;
enabling a display at the other computing device the list of candidates inline with at least some of the search criteria;
receiving at least one edit of the inline search criteria;
performing a search for a revised list of candidates employing at least the edited inline search criteria; and
enabling a display at the other computing device of the revised list of candidates inline with the edited inline search criteria.

13. The server device of claim 12, wherein the other computing device is a mobile device employable by the user to communicate with the server.

14. The server device of claim 12, wherein revising the list of candidates further comprises determining a unified search score by combining a weighted input factor associated with the compatibility feedback with at least one other weighted input factor; and employing the revised unified search score to select the revised list of candidates.

15. The server device of claim 12, wherein the at least one other weighted input factor further comprises a weighting value combined with at least one of an initial user test, an additional user test, a one-way search criteria input factor, a reverse search criteria input factor, an activity input factor, a distance input factor, an input factor reflecting the number of times the user has viewed this candidate's profile, an input factor reflecting the number of replies the candidate's profile has recently received, or an affinity input factor.

16. The server device of claim 12, wherein receiving at least one edit of the inline search criteria further comprises enabling a selection of at least one inline search criterion using a pull-down menu.

17. The server device of claim 12, wherein revised list of candidates further comprises the list of candidates in a revised rank order of candidates.

18. A modulated data signal for managing an online dating search over a network, the modulated data signal comprising instructions that enable a computing device to perform the actions of:
providing, to a server device, a user's search criteria for a candidate for a dating relationship online;
performing, at the server device, a search for a list of candidates employing the search criteria;
ranking each candidate in the list of candidates;
displaying, at a client device, the ranked list of candidates inline with at least some of the search criteria;
enabling, at the client device, editing of the inline search criteria;
employing the inline search criteria, including the edited search criteria, to automatically revise the ranking of the candidates in the list of candidates; and
displaying, at the client device, the revised ranking of the candidates inline with the edited search criteria.

19. The modulated data signal of claim 18, wherein the client device is a mobile device.

20. The modulated data signal of claim 18, wherein revising the ranking of the candidates further comprises:
determining a unified search score for each candidate, in part, by combining a weighted input factor associated with the revised search criteria with at least one other weighted input factor; and
employing the unified search score to re-rank each candidate in the list of candidates.

21. The modulated data signal of claim 18, wherein the user employs a mobile device to communicate with the server device.

22. The modulated data signal of claim 18, wherein determining the search criteria comprises enabling the user to take an online dating test.

23. An apparatus of managing an online dating search, comprising:
means for determining a user's search criteria for a candidate for a dating relationship online;
means for determining a list of candidates employing the search criteria;
means for displaying the list of candidates inline with at least some of the search criteria;
means for editing the inline search criteria; and
means for employing the inline search criteria, including the edited search criteria, to revise the candidates in the list of candidates.
